(19) United States
(12) Patent Application Publication
(10) Pub. No.: US 2007/0043876 A1
(43) Pub. Date: Feb. 22, 2007

(54) Stimulation traffic for binding refreshment

(75) Inventors: Jozsef Varga, Nagydobsza (HU); Son Phan-Anh, Budapest (HU); Gyorgy Wolfner, Budapest (HU)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/292,753

(22) Filed: Dec. 1, 2005

(30) Foreign Application Priority Data
Aug. 19, 2005 (EP) 05018080.1

(51) Int. Cl. G06F 15/16

(52) U.S. Cl. 709/245

(57) ABSTRACT

The present invention relates to a method, system, session control device and computer program product for maintaining a binding relationship in an address translation function (20) used for providing a translation between a first address used for addressing a device (10) from inside a data network and a second address used for addressing the device (10) from outside the data network. At a predetermined timing, a dedicated signaling message having at least an unknown portion not defined in the data network is generated, e.g. at a session control device (30), and transmitted to the device so as to initiate transmission of a predetermined response message via the address translation function (20). Thereby, the response message can easily be discriminated and does not require any substantial processing.

### CROSS-REFERENCE TO RELATED APPLICATION

This application claims priority under 35 USC §119 to European Patent Application No. 05018080.1 filed on Aug. 19, 2005.

### FIELD OF THE INVENTION

The present invention relates to a method, session control device, system, and computer program product for maintaining a binding relationship in an address translation function used for providing a translation between a first address used for addressing a device from inside a data network and a second address used for addressing said device from outside said data network.

### BACKGROUND OF THE INVENTION

Network Address Translators (NATs) are used to interconnect a private network consisting of unregistered IP (Internet Protocol) addresses with a global IP network using limited number of registered IP addresses. NATs are also used to avoid address renumbering in a private network when topology outside the private network changes for variety of reasons, such as customers changing Service Providers, company backbones being reorganized, or Service Providers merging or splitting. In addition, there are many other applications of NAT operation.

Basic Network Address Translation or Basic NAT is a method by which IP addresses are mapped from one group to another, transparent to end users. Network Address Port Translation, or NAPT is a method by which many network addresses and their Transmission Control Protocol/User Datagram Protocol (TCP/UDP) ports are translated into a single network address and its TCP/UDP ports. Together, both these operations are referred to as traditional NAT.

Another type of address translation when the private network and the global IP network use different IP versions, e.g., the private network uses IPv4, while the global network uses IPv6. In this case a Network Address Translation—Protocol Translator (NAT-PT) or a Network Address and Port Translation—Protocol Translator (NAPT-PT) are used between the networks.

Unless mentioned otherwise, the term NAT, as used hereinafter, will pertain to traditional NAT, namely basic NAT, NAPT as defined in the IETF (Internet Engineering Task Force) specification RFC 2663, NAT-PT, NAPT-PT as defined in the IETF RFC 2766, and to the devices performing these functions, e.g., Network Address Translators, and Network Address and Port Translators—Protocol Translators.

NATs require packets flowing from the inside (private network) to the outside (public network), to create a NAT binding and to maintain the NAT binding. NAT bindings can be specific to a single source address, to source Transport Address (IP address and port) or in certain NAT types even to Source and Destination Transport Address pair. Since a NAT has only a limited number of IP addresses and ports to allocate, a NAT binding is typically released after a certain time of inactivity. In other words, it is assumed that the binding is no longer needed. This means that in order to create and maintain a NAT binding the concerned device which will use the source address has to send data packets. However, this is not always convenient because, for example, the concerned device may not be sending data packets at this stage or not frequently enough, for example when the device is active and registered to a VoIP (Voice over IP) network but is just waiting for the incoming call. Although NAT bindings can be statically provisioned, using such a method lacks flexibility and requires a lot of provisioning. Furthermore there are still NAT devices that are out of control of the service (for example VoIP service) operator.

NAT binding discovery can be done through the use of a protocol such as Simple Traversal of UDP through NATs (STUN). STUN is an IETF Protocol, defined in the IETF RFC 3489, that allows applications to discover the presence and types of NATs in a network, as well as discovering the actual NAPT binding used for a particular media flow. However, using STUN requires the concerned device to support STUN and the use of new network components (STUN clients and servers).

In current access networks NAT devices performing address and port translation are widely deployed. In general, the access network can contain more than one NAT device. As regards NAT traversal for the Session Initiation Protocol (SIP), there can be cases where NAT devices in the access network are operated by others than the operator of the SIP core network (for example an Internet Protocol Multimedia Subsystem (IMS)) or even in end users' premises. Thus, it cannot be assumed that a SIP core server (for example a Proxy Call Session Control Function (P-CSCF)) can control those NAT device(s). Whenever a terminal device, such as mobile phone or user equipment (UE) accesses an outbound SIP proxy via a NAT device, the NAT creates a binding. This binding will be released after a reasonable time if no packet belonging to that binding has been forwarded. If the binding is released, the terminal device becomes unavailable from the outbound SIP proxy.

The lifetime problem of the NAT binding when UDP is used can be resolved if the terminal device periodically sends some kind of refreshing messages over that “UDP connection” with adequate frequency. Some NAT types refresh the binding upon incoming (SIP server to terminal) traffic also but that is not the general behavior. The interval of sending the refreshing messages should be adjusted to the binding lifetime in the NAT device, that is in term of tens of seconds. This relatively short binding lifetime implies that the refreshing frequency is very high compared to the normal rate for signaling and therefore can cause performance problem for the outbound SIP proxy.

As the refreshing messages are not supported by every terminal device, it is necessary for the outbound SIP proxy to provide a solution to send refreshing messages as well. However the impact of this solution on performance of the outbound SIP proxy must be kept at a minimum. It is noted that the refreshing messages must be sent from the same port where the normal signalling traffic is sent to the terminal device.

Several techniques have been proposed for maintaining UDP NAT bindings.

In a first most light-weight technique with least performance impacts, the outbound SIP proxy sends a dummy UDP packet (i.e., UDP packet with some “all 1” or “all 0” bytes payload) to the UE's NAT-ed IP address and port. However, several NAT devices refresh the NAT binding based only on outbound traffic (traffic from SIP client to outbound SIP proxy). This technique will not refresh the NAT binding in those NAT devices. If incoming packets update refresh binding timers, an external attacker can keep address mappings alive forever and attack future devices that may end up with the same internal address.

In a second technique which prevents the above problem associated with the first technique, the outbound SIP proxy reduces the expiry time for the registration in the SIP REGISTER method to a value lower than the typical UDP NAT binding lifetime, for example 20 seconds. The SIP client is then forced to resend a REGISTER message every 20 seconds, which then refreshes the NAT binding. However, this second technique is a very heavy-weight technique, as SIP REGISTER is a rather heavy method which typically needs performance-wise high-cost operations like database updates or authentication, especially if a third-party authentication server is used. Furthermore, typically, the outbound SIP proxy is not the registrar, so that the heavy load must either be propagated until the registrar is reached or must be filtered at the outbound SIP proxy, which requires a back-to-back user agent (B2BUA) mode in the outbound SIP proxy. Furthermore, filtering may not be possible if authentication is needed at each re-registration.

In a third technique which also prevents the above problem associated with the first technique, the outbound SIP proxy periodically sends some lightweight and state-wise neutral SIP method like OPTIONS or NOTIFY to the SIP user agent (UA) behind a NAT device. The response sent back by the SIP UA will generate outbound traffic that refresh the NAT binding. However, this third technique is still heavier than using a dummy UDP packet. After identifying the response type (e.g. SIP response to a NOTIFY request) it is also necessary to differentiate responses received for the ‘keep-alive’ requests or stimulation traffic generated by the outbound SIP proxy from the responses sent as part of normal SIP signaling traffic between endpoints, thus it requires further investigation of the SIP response.

### SUMMARY OF THE INVENTION

It is therefore an object of the present invention to provide an improved scheme for maintaining address bindings, which will work with existing deployments and at low performance cost.

This object is achieved by a method of maintaining a binding relationship in an address translation function used for providing a translation between a first address used for addressing a device from inside a data network and a second address used for addressing said device from outside said data network, said method comprising the steps of:
generating at a predetermined timing a dedicated signaling message having at least an unknown portion not defined in said data network; and
transmitting said dedicated signaling message to said device so as to initiate transmission of a predetermined response message via said address translation function.

Furthermore, the above object is achieved by a session control device for controlling data transmission between a first network and a second network, said network controller device comprising:
binding refresh means for generating at a predetermined timing a dedicated signaling message having at least an unknown portion not defined in said data network in order to maintain a binding relationship between a first address used for addressing a device in said first network and a second address used for addressing said device in said second network; and
signaling control means for transmitting said dedicated signaling message to said device so as to initiate transmission of a predetermined response message via said address translation function.

Additionally, the above object is achieved by a system for maintaining a binding relationship between a first address used for addressing a device in a first network and a second address used for addressing said device in said second network, said system comprising the session control device defined above and an address translator device for providing a translation between said first address and said second address and for initiating a binding refresh operation upon receipt of said predetermined response message.

Finally, the above object is achieved by a computer program product comprising code means stored on a readable medium for producing the steps of the above method, when run on a computer device. Thereby, the proposed solution can be implemented simply by introducing new software routines at the respective session control device. This significantly reduces cost of implementation.

Accordingly, a predetermined response message is provoked by the dedicated signaling message used for refreshing, so that the response message may easily be discriminated and does not require any substantial processing. Moreover, the dedicated signaling message can be generated and handled by a separated function or unit which is not related to other network functions. Thus, handling logic for this high-frequency SIP method can be separated from all other logics and can be implemented as lightweight as possible.

The signaling control means may be configured to recognize the predetermined response message and to apply a dedicated or specific different handing for the message. This dedicated handling may for example comprise discarding the predetermined response without full processing.

The dedicated signaling message may be an unknown message not defined in the network, wherein the predetermined response message is an error response, which can be easily discriminated and filtered or discarded to keep performance cost low.

As an alternative option, the dedicated signaling message may comprise a fixed header pattern not defined in the data network, wherein the predetermined response message comprises this fixed header pattern and can thus also be discriminated readily at low performance cost. In particular, the response message could be filtered by using the fixed header pattern. Optionally, the fixed header pattern may be selected from a plurality of fixed header patterns. As an example, the fixed header pattern may be provided in a Via branch of a Call-ID value of a Session Initiation Protocol message, such as at least one of an OPTIONS and a NOTIFY message. As another example, the fixed header pattern may be a fixed prefix.

The session control device, which may be an outbound proxy device, e.g. a PCSCF, for the first network, may further comprise refresh timer means for triggering transmission of the dedicated signaling message by the signaling control means at the predetermined timing. The predetermined timing is selected so that a time interval between successive transmissions of the dedicated signaling message is shorter than an expiry time of the binding relationship.

Further advantageous modifications are defined in the dependent claims.

### BRIEF DESCRIPTION OF THE DRAWINGS

The present invention will be now be described based on an embodiment with reference to the accompanying drawings in which:

FIG. 1 shows a schematic block diagram of a network architecture in which the present invention can be implemented;

FIG. 2 shows a signaling diagram indicating message exchange and resulting processing steps according to the embodiment; and

FIG. 3 shows a schematic block diagram of a session control device according to the embodiment.

### DETAILED DESCRIPTION OF THE EMBODIMENT

In the following, an embodiment will be described based on a network environment as shown in FIG. 1.

According to FIG. 1, a UE 10 provided in a first network, e.g. a private network or a radio access network with an own addressing function, is connected via a NAT functionality or device 20 and a SIP outbound proxy 30 to a second network 40, which may be a core network of a third generation mobile communication system.

In the present embodiment, address bindings at the NAT device 20 are maintained by using a dedicated signaling message which is unknown outside the outbound SIP proxy 30 for NAT binding refreshment purposes. I.e., the dedicated signaling message frequently triggers refresh operations at the NAT device 20.

The primary problem with SIP level NAT-binding refreshment is performance cost. Using conventional proxy-initiated known SIP methods like OPTIONS or NOTIFY for NAT refreshment leads to the problem that those methods can be sent as well by a remote UA. This makes differentiation between “refreshing” SIP messages and “normal” SIP messages difficult and performance suboptimal.

Using some SIP method that is unknown outside the outbound SIP proxy 30 for the NAT binding refreshment purposes can overcome this problem. As this SIP method is not used by anyone else, handling of it can be implemented as a totally separated module in the outbound SIP proxy 30, only for NAT binding keep-alive purposes. According to the ITEF specification RFC3261, a SIP UA at the UE 10 receiving an unknown SIP method must still respond with some error response, e.g. SIP 405 “Method not allowed”, and will thus generate outbound traffic for NAT binding keep-alive purposes. With very lightweight filtering defined by the unknown SIP method the response can easily be discriminated and also separated from all other SIP messages. Consequently, handling logic for this high-frequency SIP method can be separated from all other logics and can implemented as lightweight as possible.

In the following, the basic signaling steps are described based on the sequential numbering shown in FIG. 1. In step 1, the outbound SIP proxy 30, which may be a P-CSCF of an IMS provided in the core network 40, sends an unknown, non-used or non-standard message (also a new method can be defined for this purpose, i.e., a method that cannot be generated or interpreted by the UE), in the following referred to as “dedicated message”, to the UE 10 for refreshment purposes. In step 2, the dedicated message traverses the NAT device 20, but does (may) not refresh NAT binding as it forms incoming traffic. Having received the dedicated message, the UE 10 is triggered in step 3 to send an error message (or any other known response) back to the network. This response forms outgoing traffic and thus refreshes the NAT binding in step 4. In step 5, the SIP outbound proxy 30 has to process the response sent by the UE 10, which so far consumed a lot of proxy capacity especially if a plurality of UEs are to be refreshed at high frequency. Now, according to the embodiment, the UE 10 is caused by the dedicated message to send a response which the SIP outbound proxy 30 can easily detect as a response caused by a NAT binding refresh signaling and can filter or discard this response without full processing. Since the UE 10 operates according to normal SIP standards, the SIP outbound proxy 30 is able to know what kind of response the UE 10 should generate in response to receiving the dedicated message and therefore the SIP outbound proxy 30 can discriminate these responses.

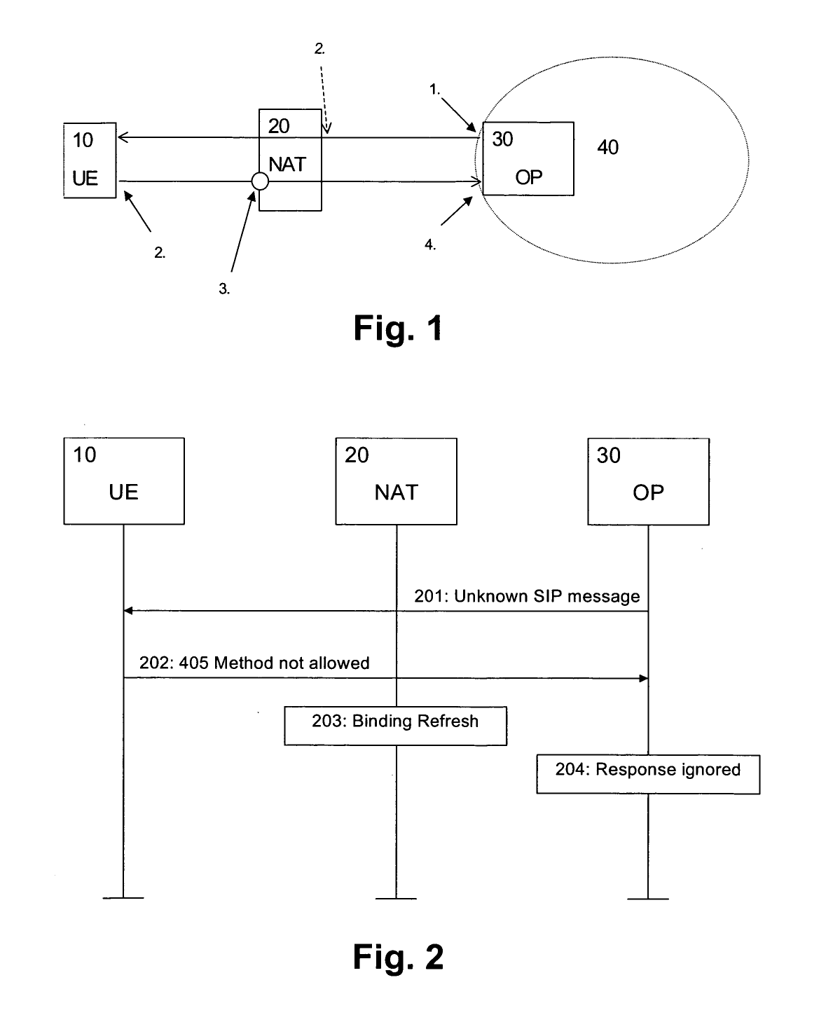

FIG. 2 shows a more detailed signaling diagram according to the embodiment, wherein signaling messages and resulting processing steps are sequentially numbered. In step 201, the SIP outbound proxy 30 generates the dedicated message as an unknown SIP message for refreshing purposes at a predetermined timing and sends it to the UE 10. The NAT device 20 sees the traversing/passing unknown SIP message in step 201 as an incoming traffic, which does not trigger any binding refresh operation. The SIP UA at the UE 10 recognizes that an unknown SIP message has been received and generates in step 202 a SIP 405 “Method not allowed” response which is transmitted back as an error message towards the SIP outbound proxy 30. At the NAT device 20, a binding refresh operation is initiated in step 203 for the NAT binding of the UE 10 due to detected outgoing traffic from UE 10. Then, in step 204, the error message is received at the SIP outbound proxy 30, where it can be easily discriminated from other responses and ignored, e.g., by a filter or discard operation.

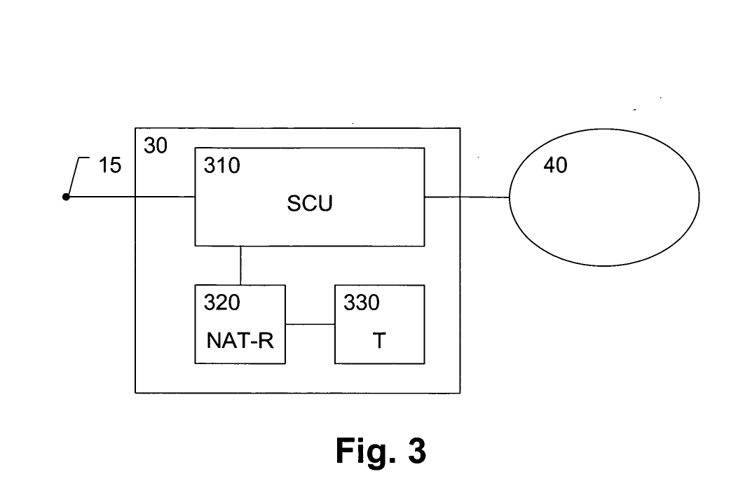

FIG. 3 shows a schematic block diagram of the SIP outbound proxy 30 according to the embodiment. According to FIG. 3, a signaling control unit 310 is provided, which is responsible for controlling generation and processing of conventional messages, receipt of conventional messages from the core network 40, and transmission of conventional messages and the new dedicated refresh messages towards the UE 10 via the NAT device 20.

According to the embodiment, a separated NAT refreshing module or unit 320 is provided which is responsible for controlling generating of the new dedicated messages at a predetermined timing. As already mentioned, the dedicated message may be a non-standard SIP method or request for NAT refreshing purposes. The predetermined timing is selected so that the interval between successive transmissions of the dedicated message is shorter than the expiry time for address bindings at the NAT device 20. As an option, a timer function or unit 330 may be provided at the SIP outbound proxy 30, which provides a counting or other timing function to assure the above predetermined timing. As an example, a control signal may be periodically issued by the timer unit 330 at the expiry of the above interval to trigger generation of the dedicated message at the NAT refreshing unit 320. The timer may be set, e.g. during system initialization, via the NAT refreshing unit 320 to provide an appropriate timing.

Additionally, the outbound SIP proxy 30 may maintain a list of NATed IP addresses and ports registered by SIP clients arranged behind the NAT device 20 and using UDP. Based on this list, the NAT refreshing unit 320 of the outbound SIP proxy 30 generates dedicated messages, e.g. “local scope unknown” SIP requests, as refreshing messages to the respective UEs, while the received responses to these requests are ignored.

The functions of NAT refreshing unit 320 and the timer unit 330 may be implemented as software routines and thus code means of a computer program product based on which a processing or computer device of the SIP outbound proxy 30 or other session control device is controlled. Thereby, implementation of the embodiment does not require any hardware modifications.

It is to be noted however, the dedicated message is not limited to an unknown, non-used or non-standard message. It may as well be a known message with an unknown, non-used or non-standard message portion, e.g. header portion. As an example, an OPTIONS or NOTIFY method may be used as the dedicated message, which has some fixed pattern in either Via branch or Call-ID value for indicating or discriminating “refreshing” requests. All values may have a fixed prefix, for example. This fixed prefix pattern can then be used to filter responses to SIP refreshing messages from all others message, to provide the same processing advantage. As stated before, since the UE 10 operates according to standard SIP, the outbound SIP proxy 30 knows what kind of responses it should expect in response to sent “refreshing” requests and thereby can easily discriminate the responses from other “real” signalling.

In summary, a method, system, session control device and computer program product have been described, for maintaining a binding relationship in an address translation function 20 used for providing a translation between a first address used for addressing a device 10 from inside a data network and a second address used for addressing the device 10 from outside the data network. At a predetermined timing a dedicated signaling message having at least an unknown portion not defined in the data network is generated, e.g. at a session control device 30, and transmitted to the device so as to initiate transmission of a predetermined response message via the address translation function 20. Thereby, the response message can easily be discriminated and does not require any substantial processing. Moreover, handling logic for the above proposed high-frequency dedicated messages, e.g. SIP methods, can be separated from all other logics and can be implemented as lightweight as possible.

It is noted that the present invention is not restricted to the above specific embodiment, but can be applied in any network environment where an address translation function with a temporary binding function is provided. Any non-defined, non-standard or non-used message type or portion can be used as the claimed dedicated signaling message. The preferred embodiment may thus vary within the scope of the attached claims.

What is claimed is:

1. A method of maintaining a binding relationship in an address translation function (20) used for providing a translation between a first address used for addressing a device (10) from inside a data network and a second address used for addressing said device (10) from outside said data network, said method comprising the steps of:
a) generating at a predetermined timing a dedicated signaling message having at least an unknown portion not defined in said data network; and
b) transmitting said dedicated signaling message to said device (10) so as to initiate transmission of a predetermined response message via said address translation function (20).

2. The method according to claim 1, wherein said dedicated signaling message is an unknown message not defined in said network, and wherein said predetermined response message is an error response.

3. The method according to claim 1, wherein said dedicated signaling message comprises a fixed header pattern not defined in said data network, and wherein said predetermined response message comprises said fixed header pattern.

4. The method according to claim 3, further comprising the step of filtering said predetermined response message by using said fixed header pattern.

5. The method according to claim 3, wherein said fixed header pattern is selected from a plurality of fixed header patterns.

6. The method according to claim 3, wherein said fixed header pattern is provided in a Via branch of a Call-ID value of a Session Initiation Protocol message.

7. The method according to claim 6, wherein said Session Initiation Protocol message is one of OPTIONS and NOTIFY message.

8. The method according to claim 3, wherein said fixed header pattern is a fixed prefix.

9. The method according to claim 1, wherein said dedicated message is generated at an outbound proxy device (30).

10. The method according to claim 1, wherein said address translation function is a Network Address Translation (NAT) binding function.

11. A session control device for controlling data transmission between a first network and a second network (40), said network controller device (30) comprising:
a) binding refresh means (320) for generating at a predetermined timing a dedicated signaling message having at least an unknown portion not defined in said data network in order to maintain a binding relationship between a first address used for addressing a device (10) in said first network and a second address used for addressing said device (10) in said second network (40); and
b) signaling control means (310) for transmitting said dedicated signaling message to said device (10) so as to initiate transmission of a predetermined response message via said address translation function (20).

12. The session control device according to claim 11, wherein said signaling control means (310) is configured to recognize said predetermined response message and to apply dedicated handling for said message.

13. The session control device according to claim 12, wherein said dedicated handling comprises discarding said predetermined response without full processing.

14. The session control device according to claim 11, further comprising refresh timer means (330) for triggering transmission of said dedicated signaling message by said signaling control means (310) at said predetermined timing.

15. The session control device according to claim 11, wherein said predetermined timing is selected so that a time interval between successive transmissions of said dedicated signaling message is shorter than an expiry time of said binding relationship.

16. The session control device according to claim 11, wherein said dedicated signaling message is an unknown message not defined in said first network, and wherein said predetermined response message is an error response.

17. The session control device according to claim 11, wherein said dedicated signaling message comprises a fixed header pattern not defined in said data network, wherein said predetermined response message comprises said fixed header pattern, and wherein said signaling control means (310) is configured to filter said predetermined response message based on said fixed header pattern.

18. The session control device according to claim 11, wherein said session control device is an outbound proxy device (30) for said first network.

19. A system for maintaining a binding relationship between a first address used for addressing a device (10) in a first network and a second address used for addressing said device (10) in said second network (40), said system comprising a session control device according to claim 11 and an address translator device (20) for providing a translation between said first address and said second address and for initiating a binding refresh operation upon receipt of said predetermined response message.

20. A computer program product comprising code means stored on a readable medium for producing the steps of method claim 1, when said code means are executed on a computer device.
